(19) United States
(12) Patent Application Publication
(10) Pub. No.: US 2025/0280904 A1
(43) Pub. Date: Sep. 11, 2025

(54) Garment Device with an Attached Electronic Display

(71) Applicant: Jen Cole, Huntington Beach, CA (US)

(72) Inventor: Jen Cole, Huntington Beach, CA (US)

(21) Appl. No.: 18/922,606

(22) Filed: Oct. 22, 2024

Related U.S. Application Data
(60) Provisional application No. 63/563,024, filed on Mar. 8, 2024.

(51) Int. Cl. A41D 1/00; G06F 3/02; G06F 3/16; H04R 1/02

(52) U.S. Cl. CPC A41D 1/002; G06F 3/02; G06F 3/165; H04R 1/028; H04R 2201/023; H04R 2499/15

(57) ABSTRACT

A garment device with an attached electronic display is provided. The device is comprised of a garment, a display screen, a speaker, and a mobile application, wherein the display screen may be attached to the hoodie and controlled by a mobile application. The mobile application may alter the design displayed, the duration of the design, and the order in which multiple designs get displayed on the display screen. The display screen may further be comprised of a speaker that allows a user to play music, which may also be controlled by the mobile application.

### CROSS-REFERENCE TO RELATED APPLICATION

The present application claims priority to, and the benefit of, U.S. Provisional Application No. 63/563,024, which was filed on Mar. 8, 2024, and is incorporated herein by reference in its entirety.

### FIELD OF THE INVENTION

The present invention relates generally to the field of garments. More specifically, the present invention relates to a garment device with an attached electronic display. The device is comprised of a garment, a display screen, a speaker, and a mobile application wherein the display screen may be attached to the garment and controlled by a mobile application. Accordingly, the present disclosure makes specific reference thereto. Nonetheless, it is to be appreciated that aspects of the present invention are also equally applicable to other like applications, devices, and methods of manufacture.

### BACKGROUND

Fashion trends change very quickly, whether it be for a season, a year, or an era. Fashion trends often come back. However, this often takes years, making the clothing and accessories of that fashion trend out of style for a long period of time. Existing clothing garments are also often boring and uninspiring in different ways, leading individuals to seek out new and unique ways of bringing their personalities into their fashion choices.

Therefore, there exists a long-felt need in the art for a device that can easily adapt to the latest fashion trend. More specifically, there exists a long-felt need in the art for a garment device with an attached electronic display that can be customized to service the fashion trend or preference of a user. Furthermore, there exists a long-felt need in the art for a garment device with an attached electronic display that can fit onto the body of any individual and that allows a user to display visual media and music.

The subject matter disclosed and claimed herein, in one embodiment thereof, comprises a garment device with an attached electronic display. The device is comprised of a garment, a display screen, a speaker, and a mobile application. The display screen may be attached to the garment and content played/displayed from the screen can be controlled by a mobile application. The mobile application may alter the media displayed, the duration of the media, and the order in which multiple media content is displayed on the display screen. The display screen may further be comprised of a speaker that allows a user to play music, which may also be controlled by the mobile application.

In this manner, the garment device with an attached electronic display of the present invention accomplishes all the foregoing objectives and provides a device that can conform to any fashion trend. More specifically, the garment device with an attached electronic display can display any image, text, design, or media to conform to the preferences of a user. Furthermore, the garment device with an attached electronic display can be applied to any person, adult, or child, not dependent on the size of the person.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a garment device with an attached electronic display primarily comprised of a garment, a display screen, a speaker, and a mobile application. The device is designed to be worn as an article of clothing in which the display screen on the garment may be changed to customize to the preferences of the user.

The device is comprised of a garment that may be made of any material commonly used for clothing and is preferably made to be worn on the torso of the user. The garment is also comprised of a first fastener that can attach to a second fastener on a rear surface of a display screen. The first and second fasteners may be any reciprocating fastener known in the art. The display screen may be any type of electronic display screen such that it can display any design preferred by the user. The display screen is further comprised of a battery, allowing it to function wirelessly, and a button that can turn the display screen on or off. The display screen may also be comprised of a speaker such that the user can listen to music or play music that coincides with the design on the display screen.

The device is further comprised of a mobile application that allows the user to customize the content shown via the display screen. A select content displayed function may allow the user to change the design of the display screen. A select time function may allow the user to change the duration in which a design is displayed on the display screen. A select sequence function may allow the user to change the order in which designs are displayed on the display screen. A select volume function may allow the user to change the volume output from the speaker.

The present invention is also comprised of a method of using the device. First, a device is provided comprised of a garment, a display screen, a speaker, and a mobile application. Then, the garment may be put onto the appropriate part of the body of the user. Then, the second fastener of the display screen may be attached to the first fastener of the garment. Next, the button of the display screen is pressed, turning the display screen on and receiving power from the battery. Then, the mobile application may be used to customize what is being displayed, for how long, and the volume output of the speaker.

The present invention is also comprised of a second method of using the device. First, a device is provided comprised of a garment, a display screen, a speaker, and a mobile application. Then, the garment may be put onto the appropriate part of the body of the user. Then, the second fastener of the display screen may be attached to the first fastener of the garment. Next, the button of the display screen is pressed, turning the display screen on and receiving power from the battery. Then, the mobile application may be used to customize what is being displayed and for how long. Then, the button may be used to control the volume output of the speaker.

Accordingly, the garment device with an attached electronic display of the present invention is particularly advantageous as it provides a device that can conform to any fashion trend. More specifically, the garment device with an attached electronic display can be applied to any adult or child of any size. Furthermore, the garment device with an attached electronic display can display any image, text, or other design to conform to the preferences of a user. In this manner, the garment device with an attached electronic display overcomes the limitations of existing garments known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a garment device with an attached electronic display of the present invention in accordance with the disclosed architecture;

FIG. 2 illustrates a side view of one potential embodiment of a garment device with an attached electronic display of the present invention in accordance with the disclosed architecture;

FIG. 3 illustrates a graphical view of a mobile application of one potential embodiment of a garment device with an attached electronic display of the present invention in accordance with the disclosed architecture;

FIG. 4 illustrates a flowchart of a method of using one potential embodiment of a garment device with an attached electronic display of the present invention in accordance with the disclosed architecture; and

FIG. 5 illustrates a flowchart of a second method of using one potential embodiment of a garment device with an attached electronic display of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can update to the latest fashion trend. More specifically, there exists a long-felt need in the art for a garment device with an attached electronic display that can be customized to service the fashion trend or preference of a user. Furthermore, there exists a long-felt need in the art for a garment device with an attached electronic display that can fit onto the body of any individual.

The present invention, in one exemplary embodiment, is comprised of a garment device with an attached electronic display. The device is primarily comprised of a garment, a display screen, a speaker, and a mobile application. The device is designed to be worn as an article of clothing in which the design on the garment may be changed to customize to the preferences of the user.

More specifically, the device is comprised of a garment. The garment may be made of any material, such as cotton, in which clothes are typically made. The garment is preferably designed to be worn on the torso, such as a hoodie or t-shirt, but may be any article of clothing to be worn on the upper or lower body of any individual. The garment, in the preferred embodiment, is further comprised of a neck hole, at least one sleeve, at least one sleeve opening, a bottom opening, and a first fastener. The neck hole allows the head of a user to extend through the garment such that the garment covers the torso up to the neck of a user. The arms of a user may pass through the sleeve openings such that the sleeves can cover the arms of the user. The bottom opening allows a user to put the garment on overhead and allows for the legs to exit the garment.

The first fastener of the garment may be used to attach a display screen to the garment. The display screen may be any type of electronic display screen. The display screen is further comprised of a battery, a charging port, and a button. The battery of the display screen may store power by inserting a charging cord into the charging port. Then, by pressing the button, the device may be turned on, sending power from the battery to the display screen to display any design as preferred by the user. A rear surface of the display screen is further comprised of a second fastener that can adhere to the first fastener of the garment securely. The display screen may also be comprised of a speaker to allow a user to play any type of sound from the display screen to accompany the design on the display screen.

The device is further comprised of a mobile application. The mobile application may be comprised of different functions that allow the user to customize the content of the display screen. The mobile application may be comprised of a select content displayed function that allows the user to change the image, text, or other content on the display screen. A select time function may allow the user to set a duration for the content on the display screen to be displayed. A select sequence function may allow the user to cycle through multiple different designs, with each image lasting for a set amount of time. In addition, a select volume function may allow the user to control the volume output from the speaker.

The present invention is also comprised of a method of using the device. First, a device is provided comprised of a garment, a display screen, a speaker, and a mobile application. Then, the garment may be put onto the appropriate part of the body of the user. Then, the second fastener of the display screen may be attached to the first fastener of the garment. Next, the button of the display screen is pressed, turning the display screen on and receiving power from the battery. Then, the mobile application may be used to customize what is being displayed, for how long, and the volume output of the speaker.

The present invention is also comprised of a second method of using the device. First, a device is provided comprised of a garment, a display screen, a speaker, and a mobile application. Then, the garment may be put onto the appropriate part of the body of the user. Then, the second fastener of the display screen may be attached to the first fastener of the garment. Next, the button of the display screen is pressed, turning the display screen on and receiving power from the battery. Then, the mobile application may be used to customize what is being displayed and for how long. Then, the button may be used to control the volume output of the speaker.

Accordingly, the garment device with an attached electronic display of the present invention is particularly advantageous as it provides a device that can conform to any fashion trend. More specifically, the garment device with an attached electronic display can display any image, text, or other design to adhere to the preferences of a user. Furthermore, the garment device with an attached electronic display can be applied to any person regardless of size. In this manner, the garment device with an attached electronic display overcomes the limitations of existing garments known in the art.

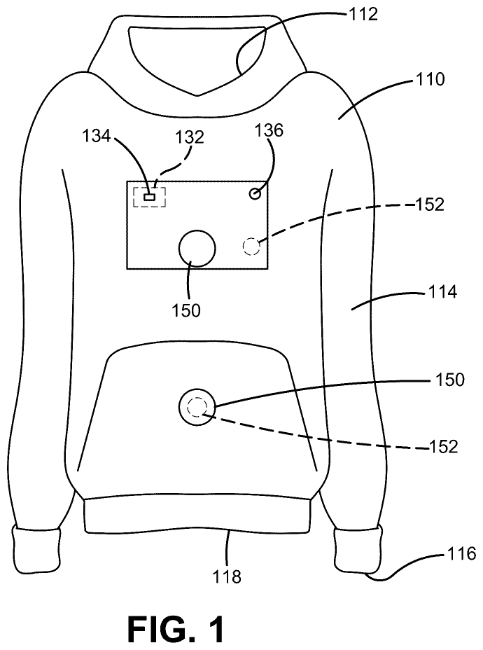

Referring initially to the drawings, FIG. 1 illustrates a front view of one potential embodiment of a garment device with an attached electronic display 100 of the present invention in accordance with the disclosed architecture. The device 100 is primarily comprised of a garment 110, at least one display screen 130, at least one speaker 150, and a mobile application 160. The device 100 is designed to be worn as an article of clothing in which the design on the garment 110 may be changed to customize to the preferences of the user via the display screen 130.

The device 100 is comprised of a garment 110 that may be made of any material commonly used for making clothes, such as, but not limited to, cotton, latex, nylon, linen, polyester, denim, rayon, fur, etc. Further, the garment 110 is preferably any type of garment to be worn on the upper body, such as, but not limited to, a short sleeve t-shirt, a long sleeve t-shirt, a sweatshirt, a hoodie, a V-neck t-shirt, a polo, a cardigan, a tank top, etc. However, the garment 110 may resemble any article of clothing on any part of the body such as, but not limited to, shorts, sweatpants, socks, shoes, hats, gloves, swim trunks, jeans, trousers, etc.

The garment 110, in the preferred embodiment of the device 100, is further comprised of a neck hole 112 and at least one sleeve 114. The neck hole 112 allows the head of a user to extend out of the garment 110. The sleeves may cover the arms of the user as they pass through at least one sleeve opening 116 of the garment 110. A bottom opening 118 of the garment 110 provides a method for putting on the garment 110 as well as a place from which the lower body of an individual may exit the garment 110.

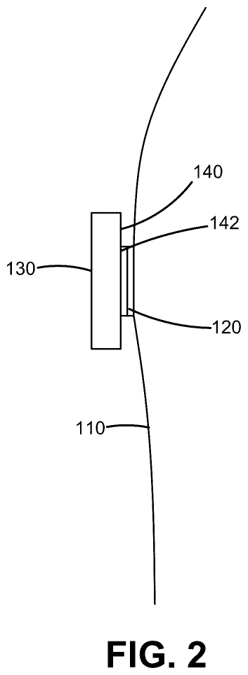

FIG. 2 illustrates a side view of one potential embodiment of a garment device with an attached electronic display 100 of the present invention in accordance with the disclosed architecture. Any portion of the garment 110 is further comprised of a first fastener 120 that can attach to a second fastener 142 positioned on a rear surface 140 of a display screen 130 to allow the display screen 130 to removably attach to the garment 110. The first fastener 120 and the second fastener 142 may be any reciprocating fasteners known in the art, but is preferably a hook-and-loop or snap button fastener. The display screen 130 may be any type of electronic display screen known in the art but is preferably an LED screen or a touch screen.

The display screen 130 is further comprised of a battery 132, a charging port 134, and a button 136. The battery 132 may store power such that the device 100 can be used without being plugged into an external power source, such as a wall outlet. The battery 132 may be a disposable battery or a rechargeable battery in the form of an alkaline, nickel-cadmium, nickel-metal hydride battery, etc., such as any 3V-12 volts DC battery or other conventional battery such as A, AA, AAA, etc. that supply power to the device 100. Throughout this specification, the term “battery” may be used interchangeably to refer to one or more wet or dry cells or batteries of cells in which chemical energy is converted into electricity and used as a source of DC power. References to recharging or replacing the battery 132 may refer to recharging or replacing individual cells, individual batteries of cells, or a package of multiple battery cells as is appropriate for any given battery technology that may be used. The battery 132 may receive power by plugging a power cord into the charging port 134 of the display screen 130, wherein the port 134 is preferably a USB port but may be any type of charging port known in the art.

The button 136 may be positioned on the display screen 130 in one embodiment and may be pressed to turn the display screen 130 and/or a speaker 150 on and control any function of the screen and/or speaker 150. The speaker 150 may emit music or any other sound at a volume set by the user using the button 136. The button 136 may also allow a user to play/pause the speaker 150. In one potential embodiment of the device 100, the button 136 may be more than a singular on/off button such that it may be able to control volume, skip to the next piece of content/media displayed by the screen 130, and/or played by the speaker 150, or access other features of the device 100. The speaker 150 may be part of the display screen 130 or separate (but in wireless or wired electrical communication via at least one transmitter 152 and/or wiring) with the display 130 in different embodiments. In said embodiments, the speaker 150 may be positioned at a different location on the garment 110 than the screen 130 for optimal sound quality/sound projection.

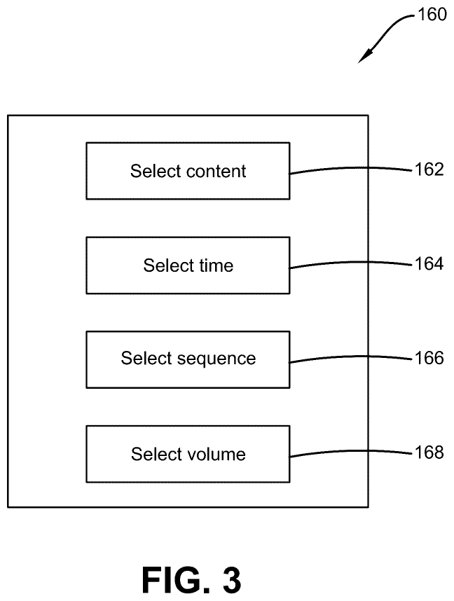

FIG. 3 illustrates a graphical view of a mobile application 160 of one potential embodiment of a garment device with an attached electronic display 100 of the present invention in accordance with the disclosed architecture. The device 100 is further comprised of a mobile application 160 comprised of various functions allowing the user to customize the content of the display screen 130. The display screen 130 and/or speaker 150 are in wireless electrical communication with the mobile application 160 (and, in one embodiment, wherein the screen 130 and speaker 150 are separate from each other) via at least one transmitter 152 such as, but not limited to, a Bluetooth or Wi-Fi transmitter. More specifically, a select content displayed 162 function may allow the user to set different content such as, but not limited to, one or multiple different images, texts, characters, faces, or any other designs, videos, photos, gifs, etc., to be displayed on the display screen 130. A select time 164 function may allow a user to set a duration for the content of the display screen 130 to be displayed. A select sequence 166 function may allow a user to cycle through multiple different content on the display screen 130 in a sequence chosen by the user. A select volume 168 function may allow a user to control the volume output from the speaker 150 of the device 100.

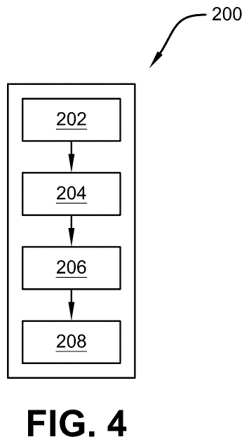

The present invention is also comprised of a method 200 of using the device 100, as seen in FIG. 4. First, a device 100 is provided comprised of a garment 110, a display screen 130 attached to the garment 110, a speaker 150, and a mobile application 160. Then, the garment 110 may be put onto the appropriate part of the body of the user [Step 202]. Next, the second fastener 142 of the display screen 130 may be attached to the first fastener 120 of the garment 110 to secure the screen 130 to the garment 110 [Step 204]. Next, the button 136 of the display screen 130 is pressed, turning the display screen 130 on [Step 206]. Then, the mobile application 160 may be used to customize what content is displayed on the display screen 130 and in what sequence, for how long, and the volume output of the speaker 150 [Step 208].

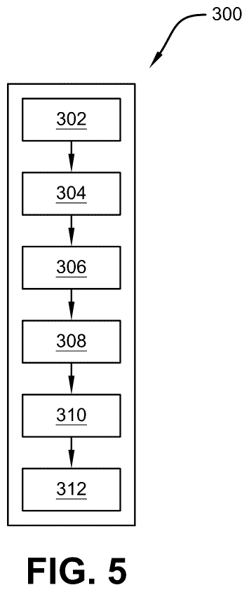

The present invention is also comprised of a second method 300 of using the device 100, as seen in FIG. 5. First, a device 100 is provided comprised of a garment 110, a display screen 130 attached to the garment 110, a speaker 150, and a mobile application 160 [Step 302]. Then, the garment 110 may be put onto the appropriate part of the body of the user [Step 304]. Next, the second fastener 142 of the display screen 130 may be attached to the first fastener 120 of the garment 110 [Step 306]. Next, the button 136 of the display screen 130 is pressed, turning on the display screen 130 [Step 308]. Then, the mobile application 160 may be used to customize what is being displayed on the display screen 130 and in what sequence, and for how long [Step 310]. In addition, the button 136 of the display screen 130 may be used to control the volume output of the speaker 150 [Step 312].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “garment device with an attached electronic display” and “device” are interchangeable and refer to the garment device with an attached electronic display 100 of the present invention.

Notwithstanding the foregoing, the garment device with an attached electronic display 100 of the present invention and its various components can be of any suitable size and configuration as is known in the art without affecting the overall concept of the invention, provided that they accomplish the above-stated objectives. One of ordinary skill in the art will appreciate the size, configuration, and material of the garment device with an attached electronic display 100 as shown in the FIGS. are for illustrative purposes only, and that many other sizes and shapes of the garment device with an attached electronic display 100 are well within the scope of the present disclosure. Although the dimensions of the garment device with an attached electronic display 100 are important design parameters for user convenience, the garment device with an attached electronic display 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A garment device with an attached electronic display comprising:
a garment;
a transmitter;
a first fastener positioned on the garment;
a display screen;
a second fastener positioned on the display screen;
a speaker; and
a mobile application.

2. A garment device with an attached electronic display of claim 1, wherein the speaker is positioned on the display screen.

3. A garment device with an attached electronic display of claim 1, wherein the first fastener and the second fastener are comprised of a pair of reciprocating fasteners.

4. A garment device with an attached electronic display of claim 3, wherein the first fastener and the second fastener are comprised of a pair of hook and loop fasteners.

5. A garment device with an attached electronic display of claim 1, wherein the display screen is comprised of a touchscreen or an LED screen.

6. A garment device with an attached electronic display of claim 1, wherein the mobile application controls the display screen.

7. A garment device with an attached electronic display of claim 1, wherein the mobile application controls the speaker.

8. A garment device with an attached electronic display of claim 1, wherein the garment is comprised of a short sleeve t-shirt, a long sleeve t-shirt, a sweatshirt, a hoodie, a V-neck t-shirt, a polo, a cardigan, or a tank top.

9. A garment device with an attached electronic display comprising:
a garment;
a transmitter;
a button;
a first fastener positioned on the garment;
a display screen;
a second fastener;
a speaker; and
a mobile application.

10. A garment device with an attached electronic display of claim 9, wherein the garment is comprised of a short sleeve t-shirt, a long sleeve t-shirt, a sweatshirt, a hoodie, a V-neck t-shirt, a polo, a cardigan, or a tank top.

11. A garment device with an attached electronic display of claim 9, wherein the first fastener and the second fastener are comprised of a pair of reciprocating fasteners.

12. A garment device with an attached electronic display of claim 11, wherein the first fastener and the second fastener are comprised of a pair of snap button fasteners.

13. A garment device with an attached electronic display of claim 9, wherein the button controls a function of the display screen.

14. A garment device with an attached electronic display of claim 9, wherein the button controls a function of the speaker.

15. A garment device with an attached electronic display of claim 9, wherein the display screen and the speaker are powered by a battery.

16. A garment device with an attached electronic display of claim 15, wherein the battery is comprised of a charging port.

17. A garment device with an attached electronic display of claim 9, wherein the speaker and the display screen are in wireless electrical communication with the mobile application.

18. A method of using a garment device with an attached electronic display, the method comprising the following steps:
providing a garment device with an attached electronic display comprised of a garment, a display screen attached to the garment, and a speaker;
putting on the garment;
attaching the display screen to the garment; and
customizing a content display on the display screen or played by the speaker.

19. A garment device with an attached electronic display of claim 18, wherein the display screen and the speaker are controlled by a button.

20. A garment device with an attached electronic display of claim 18, wherein the display screen and the speaker are controlled by a mobile application.
